(19) United States
(12) Patent Application Publication
(10) Pub. No.: US 2025/0007304 A1
(43) Pub. Date: Jan. 2, 2025

(54) TO-SW295 SWITCH ADAPTER

(71) Applicant: Guangzhou Zhongtianxin Electronic Technology Co., Ltd., Guangzhou (CN)

(72) Inventor: Zhenghui FU, Guangzhou (CN)

(73) Assignee: Guangzhou Zhongtianxin Electronic Technology Co., Ltd., Guangzhou (CN)

(21) Appl. No.: 18/453,657

(22) Filed: Aug. 22, 2023

(30) Foreign Application Priority Data
Jun. 30, 2023 (CN) 202321692794.3

(51) Int. Cl. H02J 7/00

(52) U.S. Cl. CPC H02J 7/0044; H02J 7/0024; H02J 7/0049

(57) ABSTRACT

The invention discloses TO-SW295 Switch adapter, which comprises a shell with controller charging slots, placing slots, first grooves, power switch, power cord, USB3.0 interface, take-up slots, TYPE-C charging cable, first gaskets, second grooves, console tray and second gaskets. First grooves are arranged in a plurality of the placing slots; The lower surface of the shell is fixedly connected with a plurality of first gaskets, and the lower surface of the console tray is fixedly connected with two second gaskets; The lower surface of the shell is provided with a second groove corresponding to the position of the console tray; The lower surface of the shell is provided with a take-up slot, and the TYPE-C charging cable is arranged in the take-up slot; The invention integrates the functions of charging and storage, has powerful function and better practicability, which can improve user experience.

### CROSS-REFERENCE TO RELATED APPLICATIONS

The application claims priority to Chinese patent application No. 202321692794.3, filed on Jun. 30, 2023, the entire contents of which are incorporated herein by reference.

### TECHNICAL FIELD

The invention relates to the technical field of Switch power adapter, in particular to the TO-SW295 Switch adapter.

### BACKGROUND

At present, most of the similar Switch power adapter devices on the market are AC to low-voltage transformers, whose shell extends a type-c connector line to charge the Switch, which has the disadvantage of single function. At the same time, the similar Switch storage base requires an external adapter to achieve charging and storage functions. And it can not charge Switch joy con and other electronic accessories, resulting in unable to meet user needs.

### SUMMARY

The invention aims to provide TO-SW295 Switch adapter to solve the problems raised in the background technology.

In order to solve the above technical problems, the invention provides the following technical solutions: The TO-SW295 Switch adapter comprises a shell in which a console tray is slithered, a power cable is provided on one side of the console tray, and a TYPE-C charging cable is provided on the other side, one end of the power cable is electrically connected with a plug, and the other end is electrically connected with a power switch, and the power switch is fixed on the shell. The power switch is electrically connected with a transformer, and the TYPE-C charging line is electrically connected with the transformer, the transformer electrically connected with the controller and the USB3.0 interface, and the USB3.0 interface is arranged on one side of the outer wall of the shell, the controller is installed on the upper surface of the shell, the controller electrically connected with a plurality of charging slots, and the charging slots are arranged on both sides of the controller. One side of the controller is provided with a plurality of placement slots.

Preferably, a first groove is provided in each of the placing slots.

Preferably, the lower surface of the shell is fixedly connected with a plurality of first gaskets, and the lower surface of the console tray is fixedly connected with two second gaskets.

Preferably, the lower surface of the shell is provided with a second groove corresponding to the position of the console tray.

Preferably, a take-up slot is provided on the lower surface of the housing, and the TYPE-C charging cable is arranged in the take-up slot.

The TO-SW295 Switch adapter provided by the invention has the advantages: the invention integrates the functions of charging and storage, can charge the Switch console and accessories, and provides storage space for the Switch, and simultaneously is equipped with the game card storage function, has powerful functions and better practicability, which can improve the user experience.

### BRIEF DESCRIPTION OF DRAWINGS

In order to explain embodiment of the invention or the technical scheme of the prior art more clearly, the following will be a simple introduction to the embodiment or the figures required to be used in the description of the prior art. It is obvious that the figures in the description below are some embodiment of the invention. For ordinary technical personnel in the field, under the premise of not paying creative labor, other figures can also be obtained from these.

FIG. 1 is a schematic diagram of the overall three-dimensional structure of the invention;

FIG. 2 shows the three-dimensional section view of part of the console tray under the extraction state of the invention;

FIG. 3 is a schematic diagram of the overall three-dimensional structure of the invention from another angle;

FIG. 4 is a schematic diagram of charging and storing the switch console and accessories by using the invention.

In the figures: 1. shell; 11, controller; 12. charging slots; 13, placing slot; 14, the first groove; 15, power switch; 16, power cord; 17, USB3.0 interface; 18, take-up slot; 19, TYPE-C charging cable; 110, the first gasket; 111, the second groove; 112, plug; 113, transformer; 2, console tray; 21, the second gasket.

### DETAILED DESCRIPTION OF THE EMBODIMENTS

In order to make the purpose, technical scheme and advantages of the embodiment of the invention more clearly, the technical scheme will be described clearly and completely in combination with the figures attached to that. Obviously, the described embodiment is a part of those of the invention, but not all. Based on the embodiment of the invention, all of others obtained by ordinary technical personnel in the field without creative labor all belong to the scope of protection of the invention.

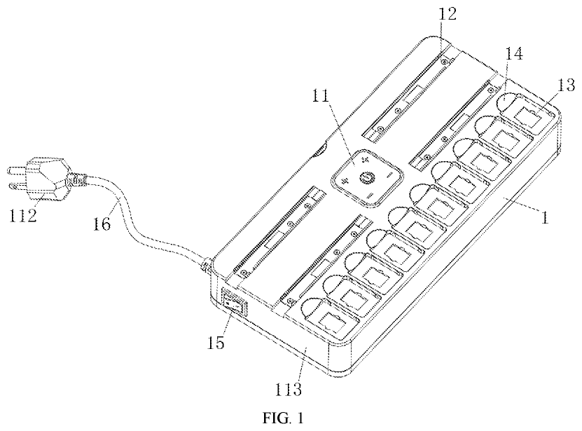

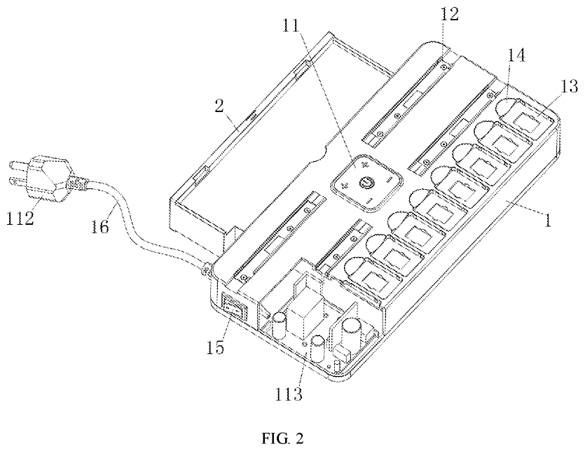

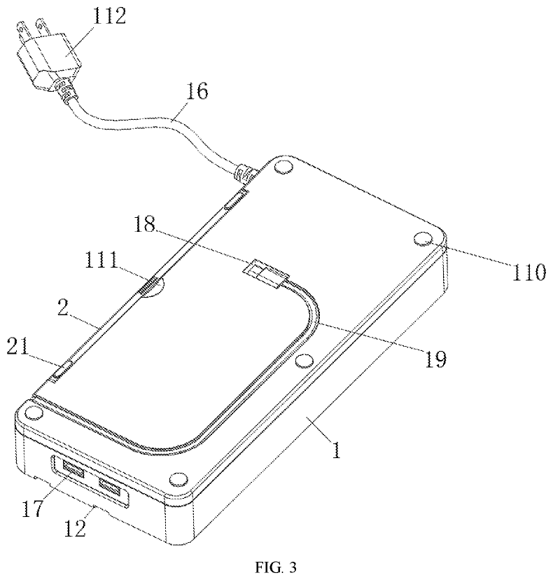

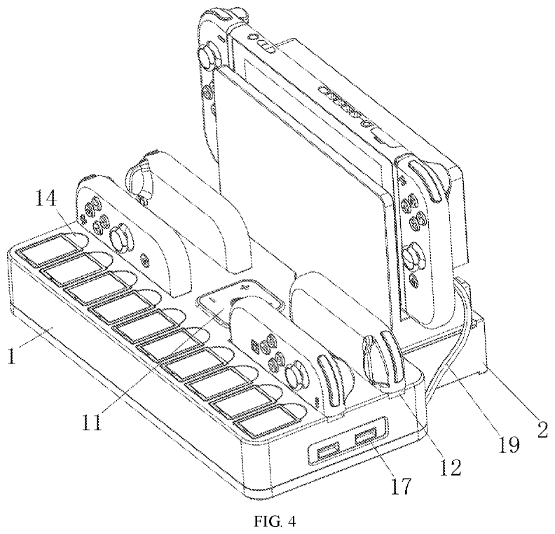

See FIG. 1-4 for an embodiment of the invention: The TO-SW295 Switch adapter, comprising a shell (1), a console tray (2) is sliding connected in the shell (1), a power cord (16) is provided on one side of the console tray (2), a TYPE-C charging cable (19) is provided on the other side, one end of the power cord (16) is electrically connected with a plug (112), and the other end is electrically connected with a power switch (15) which is fixedly connected to the shell (1), the power switch (15) is electrically connected to the transformer (113), and the TYPE-C charging line (19) is electrically connected to the transformer (113) which is electrically connected to the controller (11) and the USB3.0 interface (17), and the USB3.0 interface (17) is arranged on one side of the outer wall of the shell (1). The controller (11) is installed on the upper surface of the shell (1), and is electrically connected with a plurality of charging slots (12) whose are arranged on both sides of the controller (11). A plurality of placing slots (13) are arranged on one side of the controller (11); Those first groove (14) are provided in a plurality of placing slots (13); A plurality of first gaskets (110) are fixed on the lower surface of the shell (1), and two second gaskets (21) are fixed on the lower surface of the console tray (2); A second groove (111) is provided on the lower surface of the shell (1) corresponding to the position of the console tray (2); take-up slot (18) is provided on the lower surface of the shell (1), and the TYPE-C charging cable (19) is arranged in take-up slot (18).

How it works: when the invention is used to charge and store the Switch console and accessories, the Switch console and the standard Switch base can be placed on the console tray (2), and the TYPE-C charging cable (19) can be inserted into the charging port of the standard base of the switch console, and the switch joy con can be placed in the charging slot (12). Other accessories can be connected to USB3.0 interface (17), and then plug (112) into the external power supply, start the power switch (15), AC is transferred through the power line (16) and power switch (15) to the transformer (113). charging slot (12), TYPE-C charging cable (19) and USB3.0 port (17) are supplied with weak current after converted through the transformer (113); Among them, controller (11) and power switch (15) are equipped with indicator function, controller (11) is used for switch joy con charging control, the indicator light changes color after fully charged. Placing slot (13) is used to place the game cards. The first groove (14) is used to facilitate taking out the game cards. Tack-up slot (18) is used to store the TYPE-C charging cable (19). The second groove (111) is used to facilitate opening the console tray (2). The first gasket (110) is used to support the shell (1). The second gasket (21) is used to support the console tray (2). The invention is suitable for charging electronic products of PD protocol 15V/2.6 A.

In the description of the invention, it needs to be noted that, unless otherwise expressly specified and limited, the terms “installation”, “linking” and “connection” shall be understood in a broad sense, for example, can be fixed connection, can also be detachable connection, or integrated connection; It can be mechanical connection, can also be electrical connection; It can be directly connected, or it can be indirectly connected through an intermediate medium, and can also be the connection within the two components. For ordinary technical personnel in the field, the specific meaning of the above terms in the invention can be understood in specific circumstances.

The embodiment of device described above are schematic only, where the units described as separate components may or may not be physical separating, and the components shown as units may or may not be physical units, that is, may be located in one place, or may be distributed over multiple network units. Some or all of the modules can be selected according to the actual needs to realize the purpose of this embodiment scheme. It can be understood and implemented by ordinary technicians in the field without creative labor.

Finally, it should be noted that the above embodiment is only used to illustrate the technical scheme of the invention, and not to restrict it; Notwithstanding the detailed description of the invention by reference to the foregoing embodiment, it shall be understood by ordinary technicians in the field, that the technical scheme recorded in the foregoing embodiment may still be modified or some of the technical features equivalent to be replaced; Such modification or replacement shall not separate the essence of the corresponding technical scheme from the spirit and scope of the technical scheme of each embodiment of the invention.

What is claimed is:

1. The TO-SW295 Switch adapter comprises a shell (1), which is characterized in that the console tray (2) is sliding connected in the shell (1); a power cord (16) is provided on one side of the console tray (2), a TYPE-C charging cable (19) is provided on the other side, one end of the power cord (16) is electrically connected with a plug (112), and the other end is electrically connected with a power switch (15) which is fixedly connected to the shell (1), the power switch (15) is electrically connected to the transformer (113), and the TYPE-C charging line (19) is electrically connected to the transformer (113) which is electrically connected to the controller (11) and the USB3.0 interface (17), and the USB3.0 interface (17) is arranged on one side of the outer wall of the shell (1); the controller (11) is installed on the upper surface of the shell (1), and is electrically connected with a plurality of charging slots (12) whose are arranged on both sides of the controller (11); a plurality of placing slots (13) are arranged on one side of the controller (11).

2. According to claim 1, a charging storage device applicable to switch console and accessories is characterized by: those first groove (14) are provided in a plurality of placing slots (13).

3. According to claim 1, a charging storage device applicable to switch console and accessories is characterized by: a plurality of first gaskets (110) are fixed on the lower surface of the shell (1), and two second gaskets (21) are fixed on the lower surface of the console tray (2).

4. According to claim 3, a charging storage device applicable to switch console and accessories is characterized by: a second groove (111) is provided on the lower surface of the shell (1) corresponding to the position of the console tray (2).

5. According to claim 1, a charging storage device applicable to switch console and accessories is characterized by: take-up slot (18) is provided on the lower surface of the shell (1), and the TYPE-C charging cable (19) is arranged in take-up slot (18).
